(19) United States
(12) Patent Application Publication
(10) Pub. No.: US 2014/0077463 A1
(43) Pub. Date: Mar. 20, 2014

(54) LOCKING CHUCK

(71) Applicant: Apex Brands, Inc., Sparks, MD (US)

(72) Inventor: Neil Mason, Newcastle upon tyne (GB)

(73) Assignee: Apex Brands, Inc., Sparks, MD (US)

(21) Appl. No.: 14/030,707

(22) Filed: Sep. 18, 2013

Related U.S. Application Data
(60) Provisional application No. 61/702,777, filed on Sep. 19, 2012.

(51) Int. Cl. B23B 31/12

(52) U.S. Cl. CPC B23B 31/123
USPC 279/62

(57) ABSTRACT

A chuck including a body having a nose section with an axial bore formed therein, a plurality of jaws in communication with the axial bore, a sleeve rotatably mounted about the body in operative communication with the jaws, the sleeve defining an annular groove adjacent its rear perimeter, a rear cover defining an annular ridge that is received in the annular groove of the sleeve, and a bearing having a first race, a second race and at least one bearing element, wherein one of the first race and the second race defines a ratchet, wherein the other of the first race and the second race defines a pawl, the ratchet and the pawl are configured so that when the pawl engages the ratchet, the ratchet and pawl prevent the second race from rotating in the opening direction with respect to the first race.

### CLAIM OF PRIORITY

This application claims priority to U.S. Provisional Patent Application No. 61/702,777 filed Sep. 19, 2012, the entire disclosure of which is incorporated by reference herein.

### FIELD OF THE INVENTION

The present invention relates generally to chucks for use with drills or with electric or pneumatic power drivers. More particularly, the present invention relates to a chuck of the keyless type which may be tightened or loosened by hand or actuation of the driver motor.

### BACKGROUND OF THE INVENTION

Both hand and electric or pneumatic tool drivers are well known. Although twist drills are the most common tools on such drivers, the tools may also comprise screw drivers, nut drivers, burrs, mounted grinding stones, and other cutting or abrading tools. Since the tool shanks may be of varying diameter or of polygonal cross section, the device is usually provided with a chuck adjustable over a relatively wide range. The chuck may be attached to the driver by a threaded or tapered bore.

A variety of chucks have been developed in the art. In an oblique jawed chuck, a chuck body includes three passageways disposed approximately 120° apart from each other. The passageways are configured so that their center lines meet at a point along the chuck axis forward of the chuck. The passageways constrain three jaws which are moveable in the passageways to grip a cylindrical or polygonal tool shank displaced approximately along the chuck center axis. The chuck includes a nut that rotates about the chuck center and that engages threads on the jaws so that rotation of the nut moves the jaws in either direction within the passageways. The body is attached onto the drive shaft of a driver and is configured so that rotation of the body in one direction with respect to the nut forces the jaws into gripping relationship with the tool shank, while rotation in the opposite direction releases the gripping relationship. The chuck may be keyless if it is rotated by hand. Various configurations of keyless chucks are known in the art and are desirable for a variety of applications.

As well, many of these keyless chucks have been developed which include a locking feature that prevents inadvertent loosening, or possible opening, of the jaws. Many of these locking features require that an outer sleeve rotate relative to one or more spring-like pawls that are typically non-rotatably fixed to the nut. Through rotation of the sleeve relative to the pawls, the pawls can be made to either engage or disengage locking teeth that are fixed to the chuck body in some manner Because the sleeve must rotate relative to the pawls and nut, the sleeve cannot be press fit to the nut. Rather, the sleeve is typically, at least partially, supported on the pawls the sleeve operates. As noted, because the pawls must be movable radially inwardly and outwardly to function, they typically have a spring-like construction. Support of the outer sleeve on the spring-like pawls can lead to undesired radial motion, or wobbling, during normal operation of the chuck.

To assist in preventing this undesired motion, some chucks include dust caps which are typically press-fit to a rear portion of the chuck body and have an outer perimeter that forms a gap with an inner surface of the rear perimeter of the sleeve. The size of this gap helps to limit the amount of radial motion of the sleeve relative to the chuck body. However, difficulties in manufacturing close tolerances between the outer perimeter of the dust cap and rear perimeter of the sleeve exist due to the size of the components. As well, it is not uncommon for the rear perimeter of the sleeves in these types of chucks to be slightly out-of-round due to the materials they are constructed from and the fact that the rear perimeter of the sleeve does not receive any direct structural support.

The present invention recognizes and addresses the foregoing considerations, and others, of prior art constructions and methods.

### SUMMARY OF THE INVENTION

One embodiment of a chuck in accordance with the present disclosure includes a generally cylindrical body having a nose section and a tail section, the tail section being configured to rotate with the drive shaft and the nose section having an axial bore formed therein, a plurality of jaws movably disposed with respect to the body in communication with the axial bore, a sleeve rotatably mounted about the body in operative communication with the jaws so that rotation of the sleeve in a closing direction moves the jaws toward the axis of the axial bore and rotation of the sleeve in an opening direction moves the jaws away from the axis, the sleeve defining an annular groove adjacent its rear perimeter, a rear cover defining an annular ridge extending radially outwardly from its annular outer surface, the annular ridge being received in the annular groove of the sleeve, and a bearing having a first race adjacent the body, a second race adjacent the sleeve and at least one bearing element disposed between the first race and the second race. One of the first race and the second race defines a ratchet, wherein the other of the first race and the second race defines a pawl, and the ratchet and the pawl are configured so that when the pawl engages the ratchet, the ratchet and pawl prevent the second race from rotating in the opening direction with respect to the first race.

Another embodiment of a chuck in accordance with the present disclosure includes a body having a nose section and a tail section, the tail section being configured to rotate with the drive shaft and the nose section having an axial bore formed therein, a plurality of jaws movably disposed with respect to the body in communication with the axial bore, a sleeve rotatably mounted about the body in operative communication with the jaws so that rotation of the sleeve in a closing direction moves the jaws toward the axis of the axial bore and rotation of the sleeve in an opening direction moves the jaws away from the axis, the sleeve defining a recess adjacent its rear perimeter, a rear cover defining a projection extending radially outwardly from its annular outer surface, the projection being received in the recess of the sleeve, and a bearing having a first race adjacent the body, a second race adjacent the sleeve and at least one bearing element disposed between the first race and the second race, wherein one of the first race and the second race defines a ratchet. The other of the first race and the second race defines a pawl, and the ratchet and the pawl are configured so that when the pawl engages the ratchet, the ratchet and pawl prevent the second race from rotating in the opening direction with respect to the first race.

Yet another embodiment of a chuck in accordance with the present disclosure includes a body having a nose section and a tail section, the tail section being configured to rotate with the drive shaft and the nose section having an axial bore formed therein, a plurality of jaws movably disposed with respect to the body in communication with the axial bore, a nut rotatably mounted about the body and in operative communication with the jaws so that rotation of the nut in a closing direction moves the jaws toward the axis of the axial bore and rotation of the nut in an opening direction moves the jaws away from the axis, a sleeve rotatably mounted about the body in operative communication with the nut, the sleeve defining an annular groove adjacent its rear perimeter, a rear cover received in the sleeve in a press-fit adjacent a rear perimeter of the sleeve, and a bearing having a first race adjacent the body, a second race adjacent the sleeve and at least one bearing element disposed between the first race and the second race. One of the first race and the second race defines a ratchet, wherein the other of the first race and the second race defines a pawl, and the ratchet and the pawl are configured so that when the pawl engages the ratchet, the ratchet and pawl prevent the second race from rotating in the opening direction with respect to the first race.

The accompanying drawings, which are incorporated in and constitute a part of this specification, illustrate one embodiment of the invention and, together with the description, serve to explain the principles of the invention.

### BRIEF DESCRIPTION OF THE DRAWINGS

A full and enabling disclosure of the present invention, including the best mode thereof to one of ordinary skill in the art, is set forth more particularly in the remainder of the specification, which makes reference to the accompanying figures, in which:

FIG. 1 is a longitudinal view, partly in section, of a chuck in accordance with an embodiment of the present disclosure;

FIG. 2 is an exploded view of a chuck as shown in FIG. 1;

FIG. 3 is an exploded view of the bearing and nut of the chuck as shown in FIG. 1;

FIG. 4 is a partial perspective view of the sleeve of the chuck as shown in FIG. 1;

FIG. 5A is a partial perspective view of the bearing and sleeve of the chuck as shown in FIG. 1;

FIG. 5B is a partial perspective view of the bearing and sleeve of the chuck as shown in FIG. 1;

FIG. 6 is a partial cross-sectional view of the chuck as shown in FIG. 1, taken along line 7-7; and

FIG. 7 is an exploded view of a chuck in accordance with an alternate embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the disclosure, one or more examples of which are illustrated in the accompanying drawings. Each example is provided by way of explanation of the invention, not limitation of the invention. In fact, it will be apparent to those skilled in the art that modifications and variations can be made in the present disclosure without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents.

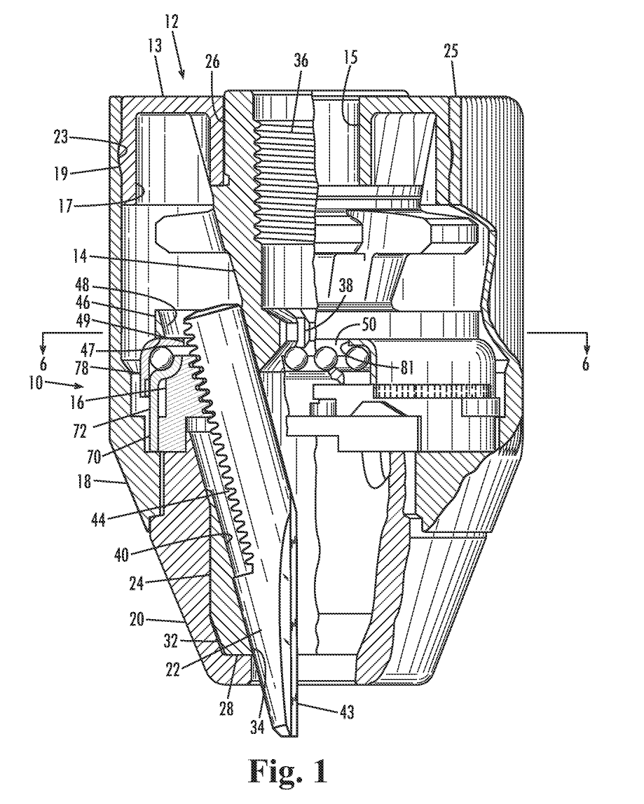

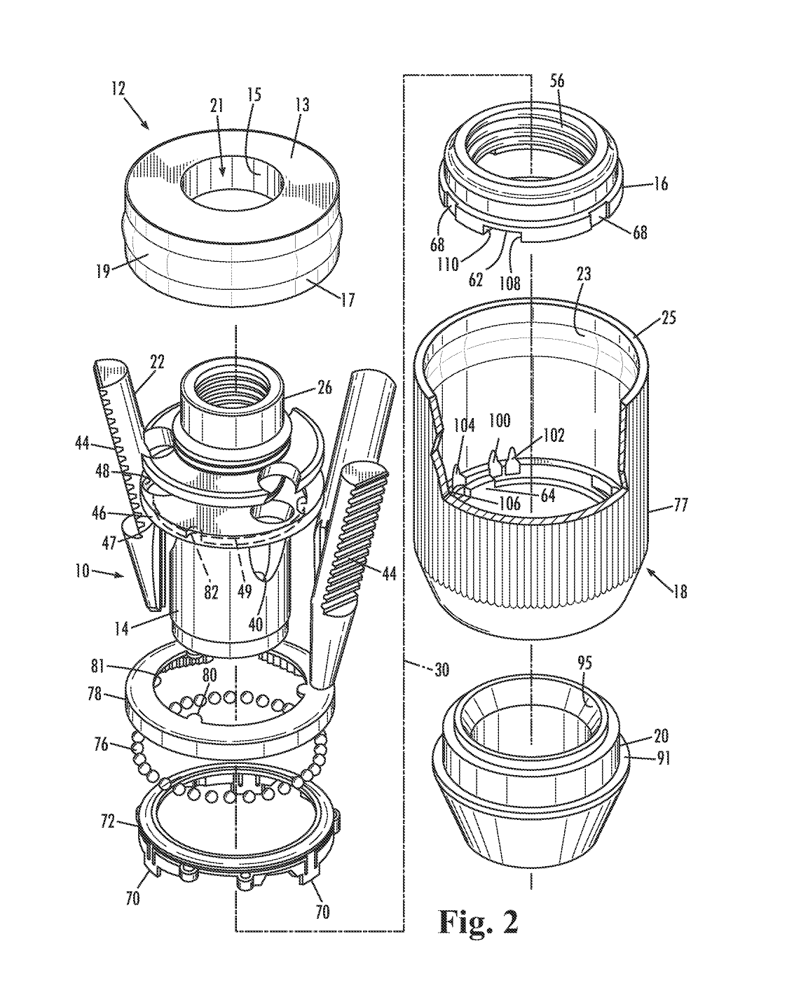

Referring to FIGS. 1 and 2, a chuck 10 includes a body 14, a nut 16, an outer sleeve 18, a rear cover 12, a nose piece 20 and a plurality of jaws 22. Body 14 is generally cylindrical in shape and comprises a nose or forward section 24 and a tail or rearward section 26. Nose section 24 has a front face 28 transverse to the longitudinal center axis 30 of body 14 and a tapered surface 32 at its forward end. The nose section defines an axial bore 34 that is dimensioned somewhat larger than the largest tool shank that the tool is designed to accommodate. A threaded bore 36 is formed in tail section 26 and is of a standard size to mate with the drive shaft of a powered or hand driver (not shown). The bores 34, 36 may communicate at a central region 38 of body 14. While a threaded bore 36 is illustrated, such bore could be replaced with a tapered bore of a standard size to mate with a tapered drive shaft. Furthermore, body 14 may be formed integrally with the drive shaft.

Body 14 defines three passageways 40 to accommodate three jaws 22. Each jaw is separated from the adjacent jaw by an arc of approximately 120°. The axes of passageways 40 and jaws 22 are angled with respect to the chuck center axis 30 such that each passageway axis travels through axial bore 34 and intersects axis 30 at a common point ahead of the chuck body. The jaws form a grip that moves radially toward and away from the chuck axis to grip a tool, and each jaw 22 has a tool engaging face 42 generally parallel to the axis of chuck body 14. Threads 44, formed on the jaw's opposite or outer surface, may be constructed in any suitable type and pitch.

As illustrated in FIGS. 1 and 2, body 14 includes a thrust ring 46 that, in a preferred embodiment, may be integral with the body. It should be understood, however, that thrust ring 46 and body 14 may be separate components. Thrust ring 46 includes a plurality of jaw guideways 48 formed around its circumference to permit retraction of jaws 22 therethrough and also includes a ledge portion 50 to receive a bearing assembly as described below. Ledge portion 50 includes a first surface 47 and a second surface 49. First surface 47 extends radially outwardly, and is perpendicular to, longitudinal center axis 30 of the chuck body. Second surface 49 extends axially along, and is concentric about, longitudinal center axis 30 of the chuck body.

Nose piece 20 retains nut 16 against forward axial movement. The nose piece is press fit to body nose section 24. It should be understood, however, that other methods of axially securing the nut on the body may be used. For example, the nut may be a two-piece nut held on the body within a circumferential groove on the outer circumference of the body, such as by a band holding the two pieces together. Nose piece 20 may be coated with a non-ferrous metallic coating to prevent rust and to enhance its appearance. Examples of suitable coatings include zinc or nickel, although it should be appreciated that any suitable coating could be utilized.

Outer sleeve 18 is secured from movement in the forward axial direction by an annular shoulder 91 on nose piece 20. A frustoconical section 95 at the rearward end of the nose piece facilitates movement of jaws 22 within the chuck. As well, the outer circumferential surface of outer sleeve 18 may be knurled or may be provided with longitudinal ribs 77 or other protrusions to enable the operator to grip it securely.

Additionally, the inner surface of outer sleeve 18 defines an annular groove 23 adjacent its rear perimeter 25. Annular groove 23 is configured to receive an annular ridge 19 extending radially outwardly from an outer annular wall 17 of rear cover 12. Rear cover 12 includes an inner annular wall 15 that defines a bore 21 that is configured to be slidably and rotatably received about rearward section 26 of chuck body 14. After outer sleeve 18 has been positioned over chuck body 14 and retained in the forward axial direction by nose piece 20, rear cover 12 is pressed into the rear perimeter 25 of outer sleeve 18 until annular ridge 19 is received in annular groove 23 in a snap-fit. So positioned, rear cover 12 serves to maintain the circular shape of rear perimeter 25 of outer sleeve 18. As well, the reduced size of bore 21 and rear portion 26 of the chuck body, as opposed to the outer perimeter of a dust cover and rear perimeter of a sleeve on a typical chuck, allow for improved accuracy of manufacturing a gap between bore 21 and the rear portion of chuck body 14 to the desired tolerances. As such, since the gap between annular inner wall 15 and the outer surface of rear portion 26 can be manufactured with increased accuracy, unwanted radial motion of outer sleeve 18 relative to chuck body 14 can be reduced, as compared to typical locking chucks.

The outer sleeve may be molded or otherwise fabricated from a structural plastic such as polycarbonate, a filled polypropylene, for example a glass filled polypropylene, or a blend of structural plastic materials. Other composite materials such as, for example, graphite filled polymerics may also be suitable in certain environments. Additionally, the outer sleeve may be fabricated from various metals. As should be appreciated by one skilled in the art, the materials for which the chuck of the present invention is fabricated will depend on the end use of the chuck, and the above materials are provided by way of example only.

Nut 16 has threads 56 for mating with jaw threads 44. Nut 16 is positioned about the body in engagement with the jaw threads so that when the nut is rotated with respect to body 14, the jaws will be advanced or retracted depending on the nut's rotational direction.

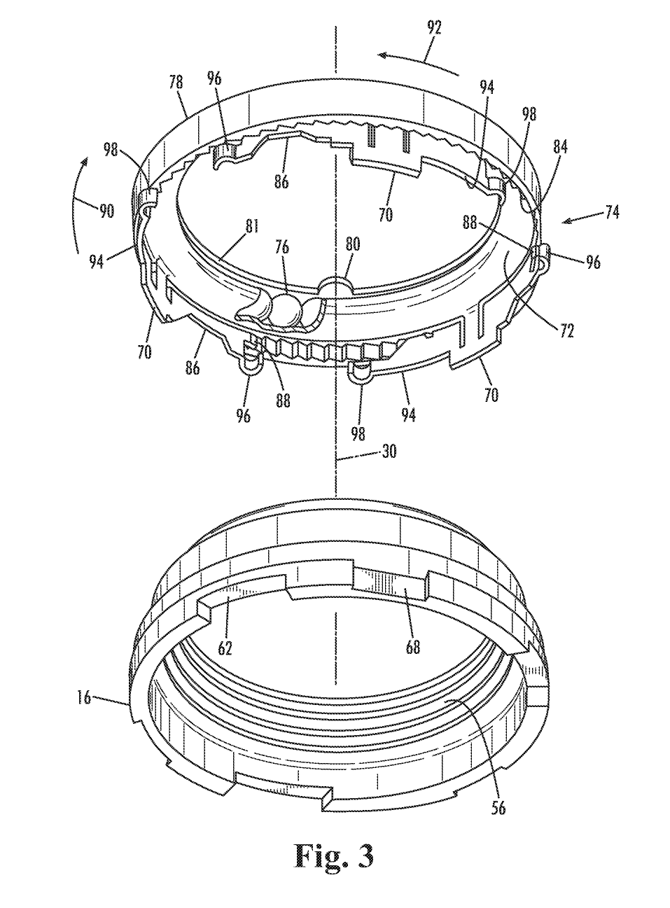

As illustrated in FIG. 3, the nut's forward axial face includes recesses 62 that receive respective drive dogs 64 (FIG. 2) extending from the inner surface of outer sleeve 18. The angular width of the drive dogs is less than that of the recesses, resulting in a slight range of relative rotational movement, for example between 6° and 10°, between the nut and the outer sleeve.

Nut 16 also defines a plurality of grooves formed as flats 68 about the nut's outer circumference. Flats 68 receive respective tabs 70 extending forward from an inner race 72 of a bearing assembly 74. The engagement of tabs 70 and flats 68 rotationally fix the inner race to the nut, although it should be understood that there may be a slight rotational tolerance between the two.

Inner race 72 receives a plurality of bearing elements 76, in this case bearing balls, disposed between it and an outer race 78 seated on thrust ring ledge 50 (FIG. 1). Outer race 78 is rotationally fixed to body 14 by a plurality of tabs 80 that extend inwardly from an inner periphery 81 of outer race 78. The plurality of tabs 80 is received in corresponding grooves 82 defined by second surface 49 of the thrust ring ledge 50.

Outer race 78 also includes a ratchet. In the illustrated embodiment, the ratchet is formed by a plurality of sawtooth-shaped teeth 84 disposed about the inner circumferential surface of the outer race. A first pawl 86 extends from one side of each tab 70 and is biased radially outward from the inner race, thereby urging a distal end 88 of each first pawl 86 toward the outer race ratchet.

Each tooth 84 has a first side with a slope approaching 90°. The second side has a lesser slope. First pawl 86 is deflectable and is generally disposed in alignment with the slope of the second side. Thus, rotation of inner race 72 in a direction 90 with respect to outer race 78 moves first pawl distal ends 88 repeatedly over teeth 84, causing a clicking sound as ends 88 fall against each subsequent tooth's second side. This configuration of teeth 84 and first pawl 86, however, prevents the inner race's rotation in an opposite direction 92. Application of rotational force to the inner race in this direction forces distal ends 88 into the steep-sloped first sides of teeth 84. Since first pawl 86 is generally perpendicular to the first sides, it does not deflect inward to permit rotation.

As discussed below, direction 90 corresponds to the chuck's closing direction, while direction 92 corresponds to the chuck's opening direction. Accordingly, when first pawls 86 engage ratchet teeth 84, the teeth permit the inner race's movement in the chuck's closing direction 90 but prevent its movement in the opening direction 92.

A second deflectable pawl 94 extends to the other side of each tab 70. Like first pawls 86, each second pawl 94 is biased radially outward. Unlike first pawls 86, however, second pawls 94 do not engage the outer race ratchet.

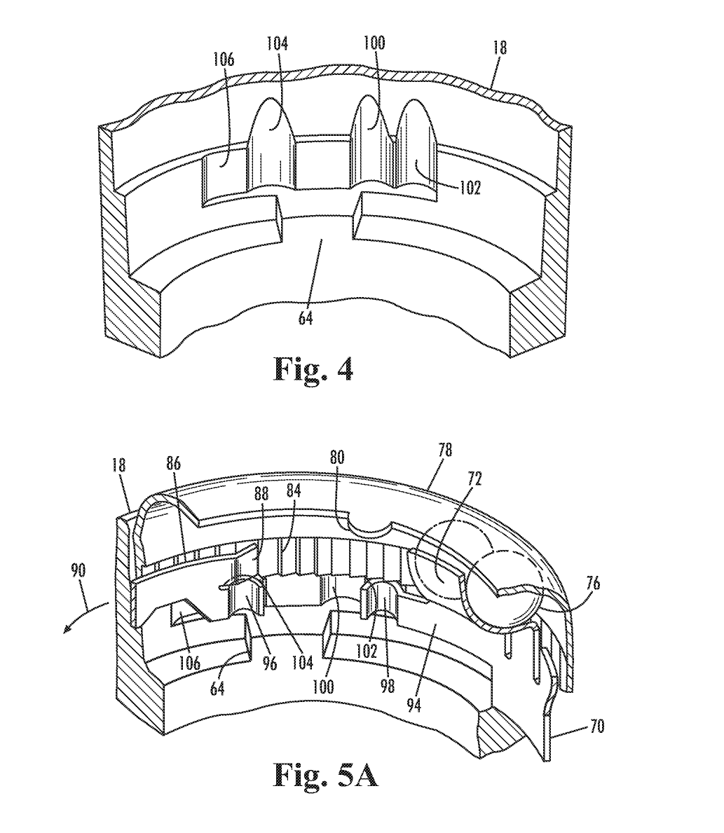

First and second pawls 86 and 94 include tabs 96 and 98 at their distal ends, respectively. Referring also to FIG. 4, an inner circumferential surface of outer sleeve 18 defines first and second recesses 100 and 102. During the chuck's operation, each tab 98 is received in one of these recesses, depending on the sleeve's rotational position with respect to the nut, as discussed in more detail below. The sleeve also defines a third recess 104 and a cam surface 106. Also depending on the sleeve's rotational position, each tab 96 is received either by cam surface 106 or by recess 104. The sleeve includes a pair of recesses 100 and 102 for each tab 98 and a recess 104 and cam surface 106 for each tab 96.

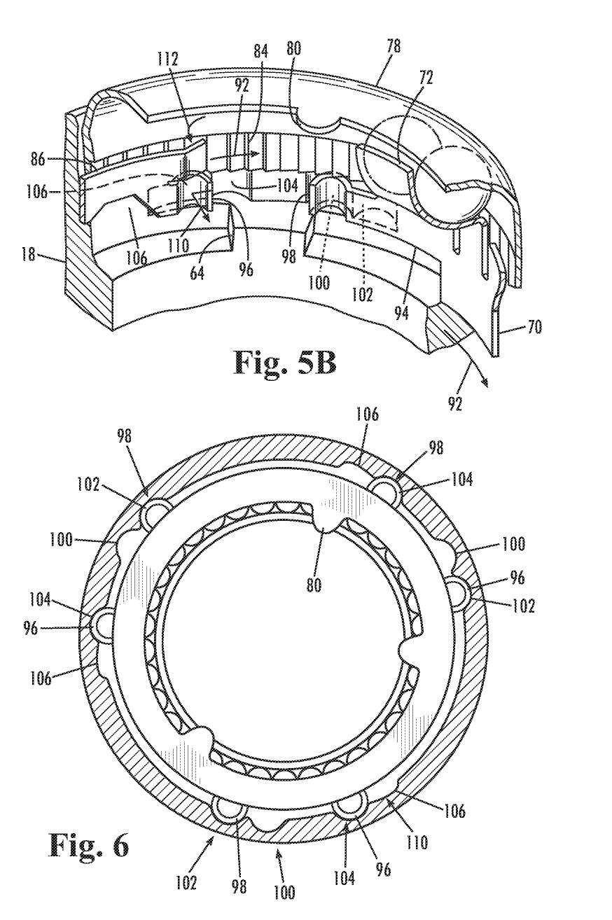

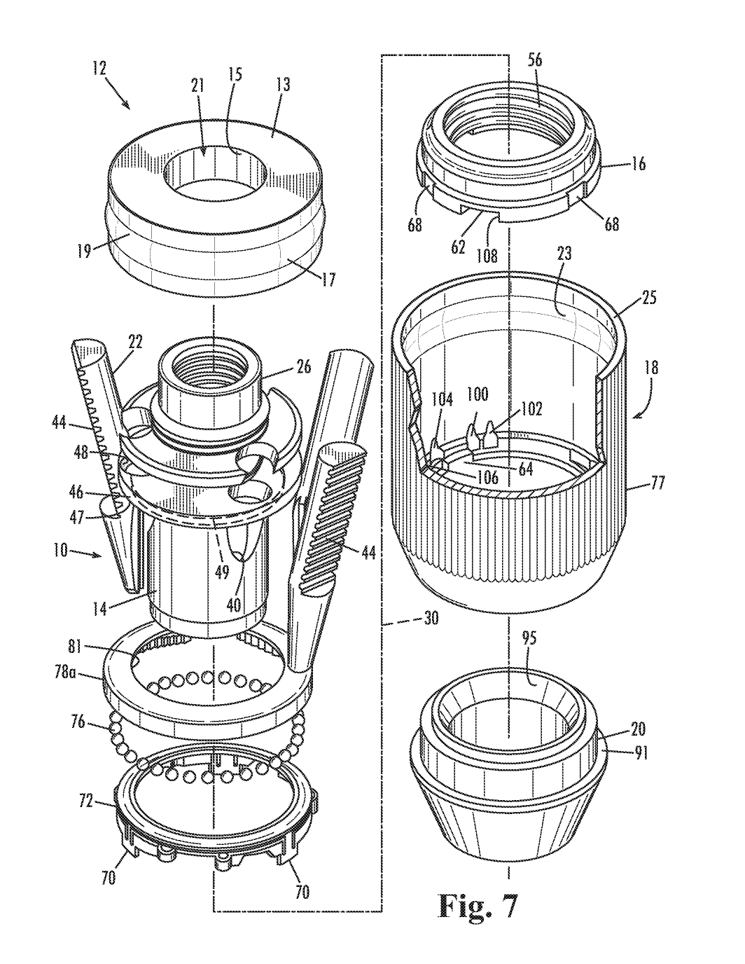

FIG. 5B illustrates the disposition of pawls 86 and 94 when sleeve 18 is in a first (disengaged) of two positions with respect to nut 16 (FIG. 2), while FIG. 5A illustrates these components when the sleeve is in a second position (engaged) with respect to the nut. For ease of illustration, both figures omit the nut. However, referring to FIG. 2 and to the sleeve's second position as shown in FIG. 5A, each drive dog 64 is disposed against or adjacent to a side 108 of the gap 62 in which is it received. Each of the sleeve's recesses 102 receives tab 98 of one of the second pawls 94, and each recess 104 receives tab 96 of one of the first pawls 86. Accordingly, the distal end 88 of each first pawl 86 engages ratchet teeth 84, and inner race 72 can rotate only in closing direction 90 with respect to outer race 78.

Referring now to FIG. 5B, when inner race 72 moves in opening direction 92 with respect to the outer race, each tab 98 moves out of its recess 102 and into its recess 100, as indicated by arrow 108. Each tab 96 rides up and out of its recess 104 onto its cam surface 106, as indicated by arrow 110. As indicated by arrow 112, this pushes each deflectable first pawl 86 radially inward, thereby disengaging distal ends 88 from ratchet teeth 84. Thus, the inner race is free to rotate with respect to the outer race in either direction.

As described in more detail below, when outer sleeve 18 rotates in opening direction 92 so that the inner race moves from the engaged position shown in FIG. 5A to the disengaged position shown in FIG. 5B, drive dogs 64 move within grooves 62 of nut 16 (FIG. 2) so that each drive dog is against or immediately adjacent to a side 110 of the groove.

In operation, and referring to FIGS. 2, 3, 5A and 5B, nut grooves 62 receive drive dogs 64 when the chuck is between fully opened and fully closed positions so that the drive dogs are adjacent groove sides 110. Inner race 72 is disposed with respect to outer race 78 so that tabs 96 and 98 are received by cam surface 106 and recess 100, respectively. That is, outer sleeve 18 is in the first position with respect to the nut. In this condition, tabs 98 and recesses 100 rotationally fix inner race 72 to outer sleeve 18. Since inner race 72 is rotationally fixed to nut 16 by tabs 70 and flats 68, an operator rotating outer sleeve 18 rotationally drives the nut through inner race 72, thereby opening or closing the jaws. When the operator rotates the outer sleeve/bearing inner race/nut in the closing direction (indicated by arrow 90 in FIG. 3) to the point that the jaws tighten onto a tool shank, the nut is urged rearward up the jaw threads, thereby pushing the nut against inner race 72, bearing elements 76, outer race 78 and thrust ring 46. The rearward force creates a frictional lock between the nut and inner race 72 that further rotationally fixes two components.

The wedge between the nut threads 56 and jaw threads 44 increasingly resists the nut's rotation. When the operator continues to rotate outer sleeve 18, and the resistance overcomes the hold provided by tabs 98 in recesses 100, outer sleeve 18 rotates with respect to nut 16 and inner bearing race 72. This moves drive dogs 64 from sides 110 of grooves 62 to sides 108 and pushes tabs 98 out of recesses 100 into recesses 102. Simultaneously, cam surfaces 106 rotate away from tabs 96 so that the tabs are released into recesses 104, thereby engaging distal ends 88 of first pawls 86 with ratchet teeth 84, as shown in FIG. 5A. At this point, inner race 72, and therefore nut 16, is rotationally locked to outer race 78, and therefore body 14, against rotation in the chuck's opening direction 92. That is, the nut is rotationally locked to the chuck body in the opening direction 92. Since the nut's rotation with respect to the body is necessary to open the chuck, this prevents inadvertent opening during use.

Inner race 72, and therefore nut 16, may, however, still rotate with respect to outer race 78, and therefore body 14, in the chuck's closing direction 90. During such rotation, sleeve 18 drives nut 16 through drive dogs 64 against groove sides 108, as well as through inner race 72. This continues to tighten the chuck and, as described above, produces a clicking sound to notify the operator that the chuck is in a fully tightened position.

To open the chuck, the operator rotates outer sleeve 18 in the opposite direction. Outer sleeve 18 transfers this torque to inner race 72 at the engagement of tabs 96 and 98 in recesses 104 and 102, respectively. Because first pawls 86 engage outer race 78, which is rotationally fixed to the body, through the ratchet teeth, the inner race cannot rotate with the outer sleeve. Thus, upon application of sufficient torque in the opening direction 92, outer sleeve 18 moves with respect to the inner race and the nut. This moves tabs 96 back up onto cam surfaces 106, thereby disengaging distal ends 88 of first pawls 86 from ratchet teeth 84. Tabs 98 move from recesses 102 into recesses 100, and drive dogs 64 move from sides 108 to sides 110 of grooves 62. Thus, the sleeve moves to its first position with respect to the nut, as shown in FIG. 5B, and the inner race and the nut are free to rotate with respect to the outer race and chuck body. Accordingly, further rotation of sleeve 18 in opening direction 92,moves jaws 22 away from the chuck axis, thereby opening the chuck.

Referring now to FIG. 7, chuck 10 is shown with alternate embodiment of an outer race 78a for use in bearing assembly 74. In contrast to the earlier described embodiment, outer race 78a does not include a plurality of tabs extending inwardly from an inner periphery 81 though. As well, second surface 49 of ledge portion 50 of chuck body 14 does not define a plurality of recesses. Rather than rotationally fixing outer race 78a to chuck body 14 with tabs and corresponding recesses, frictional forces are used to selectively fix outer race 78a to chuck body 14 while operating the chuck, as described below.

In operation, and referring to FIGS. 3, 5A, 5B, and 7, nut grooves 62 receive drive dogs 64 when the chuck is between fully opened and fully closed positions so that the drive dogs are adjacent groove sides 110. Inner race 72 is disposed with respect to outer race 78a so that tabs 96 and 98 are received by cam surface 106 and recess 100, respectively. That is, outer sleeve 18 is in the first position (disengaged) with respect to the nut. In this condition, tabs 98 and recesses 100 rotationally fix inner race 72 to outer sleeve 18 and outer race 78 is free to rotate about body 14. Since inner race 72 is rotationally fixed to nut 16 by tabs 70 and flats 68, an operator rotating outer sleeve 18 rotationally drives the nut through inner race 72, thereby opening or closing the jaws. When the operator rotates the outer sleeve/bearing inner race/nut in the closing direction (indicated by arrow 90 in FIG. 3) to the point that the jaws tighten onto a tool shank, the nut is urged rearward up the jaw threads, thereby pushing the nut against inner race 72, bearing elements 76, outer race 78a and thrust ring 46. The rearward force creates a frictional lock between the nut and inner race 72 that further rotationally fixes two components. Additionally, the rearward force increases the frictional forces between the rear surface of outer race 78a and first surface 47 of ledge portion 50, in a direction opposite to the direction that outer sleeve 18 and nut 16 are being rotated. Eventually, the frictional forces restrain rotation of outer race 78a with respect to body 14. Bearing balls 76, however, permit sleeve 18 and nut 16 to continue to rotate relative to body 14 and outer race 78a in closing direction 90.

The wedge between nut threads 56 and jaw threads 44 increasingly resists the nut's rotation. When the operator continues to rotate outer sleeve 18, and the resistance overcomes the hold provided by tabs 98 in recesses 100, sleeve 18 rotates with respect to nut 16 and inner bearing race 72. This moves drive dogs 64 from sides 110 of grooves 62 to sides 108 and pushes tabs 98 out of recesses 100 into recesses 102. Simultaneously, cam surfaces 106 rotate away from tabs 96 so that the tabs are released into recesses 104, thereby engaging distal ends 88 of first pawls 86 with ratchet teeth 84, as shown in FIG. 5A. At this point, inner race 72, and therefore nut 16, is rotationally locked to outer race 78a, and therefore body 14, against rotation in the chuck's opening direction 92. That is, the nut is rotationally locked to the chuck body in the opening direction. Since the nut's rotation with respect to the body is necessary to open the chuck, this prevents inadvertent opening during use.

Inner race 72, and therefore nut 16, may, however, still rotate with respect to outer race 78a, and therefore body 14, in the chuck's closing direction 90. During such rotation, sleeve 18 drives nut 16 through drive dogs 64 against groove sides 108, as well as through inner race 72. This continues to tighten the chuck and, as described above, produces a clicking sound to notify the operator that the chuck is in a fully tightened position.

To open the chuck, the operator rotates outer sleeve 18 in the opposite direction. Sleeve 18 transfers this torque to inner race 72 at the engagement of tabs 96 and 98 in recesses 104 and 102, respectively. Because first pawls 86 engage outer race 78a, which is rotationally fixed to the body by frictional force, through the ratchet teeth, the inner race cannot rotate with the sleeve. Thus, upon application of sufficient torque in opening direction 92, outer sleeve 18 moves with respect to the inner race and the nut. This moves tabs 96 back up onto cam surfaces 106, thereby disengaging distal ends 88 of first pawls 86 from ratchet teeth 84. Tabs 98 move from recesses 102 into recesses 100, and drive dogs 64 move from sides 108 to sides 110 of grooves 62. Thus, the outer sleeve moves to its first position with respect to the nut, as shown in FIG. 5B, and the inner race and nut are free to rotate with respect to outer race 78a and chuck body. Accordingly, further rotation of outer sleeve 18 in the opening direction moves jaws 22 away from the chuck axis, thereby opening the chuck. As well, as nut 16 is rotated in the opening direction 92 and rearward force on jaws 22 is relieved, the frictional forces locking outer race 78a to first surface 47 are reduced to the point that outer race 78a is free to rotate about the chuck's body.

In an alternate embodiment of the chuck, inner periphery 81 of outer race 78a and second surface 49 of ledge portion 50 are sized such that outer race 78a is received about body in a press-fit. This embodiment functions in a manner similar to that shown in FIG. 2, and previously described. As such, a description of the operation is not repeated here.

While one or more preferred embodiments of the present disclosure have been described above, it should be understood that any and all equivalent realizations of the present disclosure are included within the scope and spirit thereof. Thus, the depicted embodiment(s) are presented by way of example only and are not intended as limitations. It should be understood that aspects of the various one or more embodiments may be interchanged either in whole or in part. Therefore, it is contemplated that any and all such embodiments are included in the present disclosure as may fall within the literal or equivalent scope of the appended claims.

What is claimed is:

1. A chuck for use with a manual or powered driver having a rotatable drive shaft, the chuck comprising:
a generally cylindrical body having a nose section and a tail section, the tail section being configured to rotate with the drive shaft and the nose section having an axial bore formed therein;
a plurality of jaws movably disposed with respect to the body in communication with the axial bore;
a sleeve rotatably mounted about the body in operative communication with the jaws so that rotation of the sleeve in a closing direction moves the jaws toward the axis of the axial bore and rotation of the sleeve in an opening direction moves the jaws away from the axis, the sleeve defining an annular groove adjacent its rear perimeter;
a rear cover defining an annular ridge extending radially outwardly from its annular outer surface, the annular ridge being received in the annular groove of the sleeve; and
a bearing having a first race adjacent the body, a second race adjacent the sleeve and at least one bearing element disposed between the first race and the second race, wherein one of the first race and the second race defines a ratchet, wherein the other of the first race and the second race defines a pawl, and the ratchet and the pawl are configured so that when the pawl engages the ratchet, the ratchet and pawl prevent the second race from rotating in the opening direction with respect to the first race.

2. The chuck as in claim 1, wherein the pawl is biased toward the ratchet.

3. The chuck as in claim 1, wherein the sleeve includes a first sleeve and a second sleeve and wherein the first sleeve rotationally drives the second sleeve but is movable with respect to the second sleeve between a first position and a second position.

4. The chuck as in claim 3, wherein the first sleeve defines a cam surface disposed with respect to the pawl so that the cam surface disengages the pawl from the ratchet when the first sleeve is in the first position with respect to the second sleeve and releases the pawl to engage the ratchet when the first sleeve is in the second position with respect to the second sleeve.

5. The chuck as in claim 4, wherein the second sleeve is an annular nut having threads formed thereon in engagement with threads on the jaws so that rotation of the nut about the body moves the jaws toward or away from the axis.

6. The chuck as in claim 1, wherein the pawl is deflectable and wherein the pawl and the ratchet are configured so that when the pawl engages the ratchet, the pawl and ratchet permit the second race to rotate in the closing direction with respect to the first race but prevent the second race from rotating in the opening direction with respect to the first race.

7. A chuck for use with a manual or powered driver having a rotatable drive shaft, the chuck comprising:
a body having a nose section and a tail section, the tail section being configured to rotate with the drive shaft and the nose section having an axial bore formed therein;
a plurality of jaws movably disposed with respect to the body in communication with the axial bore;
a sleeve rotatably mounted about the body in operative communication with the jaws so that rotation of the sleeve in a closing direction moves the jaws toward the axis of the axial bore and rotation of the sleeve in an opening direction moves the jaws away from the axis, the sleeve defining a recess adjacent its rear perimeter;
a rear cover defining a projection extending radially outwardly from its annular outer surface, the projection being received in the recess of the sleeve; and
a bearing having a first race adjacent the body, a second race adjacent the sleeve and at least one bearing element disposed between the first race and the second race, wherein one of the first race and the second race defines a ratchet, wherein the other of the first race and the second race defines a pawl, and the ratchet and the pawl are configured so that when the pawl engages the ratchet, the ratchet and pawl prevent the second race from rotating in the opening direction with respect to the first race.

8. The chuck as in claim 7, wherein the sleeve includes a first sleeve and a second sleeve and wherein the first sleeve rotationally drives the second sleeve but is movable with respect to the second sleeve between a first position and a second position.

9. The chuck as in claim 8, wherein the first sleeve defines a cam surface disposed with respect to the pawl so that the cam surface disengages the pawl from the ratchet when the first sleeve is in the first position with respect to the second sleeve and releases the pawl to engage the ratchet when the first sleeve is in the second position with respect to the second sleeve.

10. The chuck as in claim 9, wherein the second sleeve is an annular nut having threads formed thereon in engagement with threads on the jaws so that rotation of the nut about the body moves the jaws toward or away from the axis.

11. The chuck as in claim 7, wherein the pawl is deflectable and wherein the pawl and the ratchet are configured so that when the pawl engages the ratchet, the pawl and ratchet permit the second race to rotate in the closing direction with respect to the first race but prevent the second race from rotating in the opening direction with respect to the first race.

12. A chuck for use with a manual or powered driver having a rotatable drive shaft, the chuck comprising:
a body having a nose section and a tail section, the tail section being configured to rotate with the drive shaft and the nose section having an axial bore formed therein;
a plurality of jaws movably disposed with respect to the body in communication with the axial bore;
a nut rotatably mounted about the body and in operative communication with the jaws so that rotation of the nut in a closing direction moves the jaws toward the axis of the axial bore and rotation of the nut in an opening direction moves the jaws away from the axis;
a sleeve rotatably mounted about the body in operative communication with the nut, the sleeve defining an annular groove adjacent its rear perimeter;
a rear cover received in the sleeve in a press-fit adjacent a rear perimeter of the sleeve; and
a bearing having a first race adjacent the body, a second race adjacent the sleeve and at least one bearing element disposed between the first race and the second race, wherein one of the first race and the second race defines a ratchet, wherein the other of the first race and the second race defines a pawl, and the ratchet and the pawl are configured so that when the pawl engages the ratchet, the ratchet and pawl prevent the second race from rotating in the opening direction with respect to the first race.

13. The chuck of claim 12, wherein the sleeve defines an annular groove adjacent its rear perimeter and the rear cover defines an annular ridge extending radially outwardly from its outer surface, the annular ridge being received in the annular groove of the sleeve.

14. The chuck as in claim 12, wherein the sleeve rotationally drives the nut but is movable with respect to the nut between a first position and a second position.

15. The chuck as in claim 14, wherein the sleeve defines a cam surface disposed with respect to the pawl so that the cam surface disengages the pawl from the ratchet when the sleeve is in the first position with respect to the nut and releases the pawl to engage the ratchet when the sleeve is in the second position with respect to the nut.

16. The chuck as in claim 12, wherein the pawl is deflectable and wherein the pawl and the ratchet are configured so that when the pawl engages the ratchet, the pawl and ratchet permit the second race to rotate in the closing direction with respect to the first race but prevent the second race from rotating in the opening direction with respect to the first race.
